(19) United States
(12) Patent Application Publication
(10) Pub. No.: US 2005/0093775 A1
(43) Pub. Date: May 5, 2005

(54) Method of driving a plasma display panel

(76) Inventors: Petrus Maria De Greef, Eindhoven (NL); Age Jochem Van Dalfsen, Eindhoven (NL)

Correspondence Address: Philips Electronics North America Corporation;Intellectual Property & Standards, 1109 McKay Drive, M/S41-SJ, San Jose, CA, 95131, US

(21) Appl. No.: 10/502,362

(22) PCT Filed: Jan. 14, 2003
(86) PCT No.: PCT/IB03/00065

(30) Foreign Application Priority Data
Jan. 23, 2002 (EP) 02075279.6

(51) Int. Cl. G09G 3/28

(52) U.S. Cl. 345/60

(57) ABSTRACT

The present invention relates to driving a plasma display panel including discharge cells each corresponding to a pixel in response to a video signal including fields wherein each field is formed by a plurality of subfields, wherein a sustain-level signal (AS) is applied (Q) to cause a sustaining discharge in a discharge cell for emitting light therefrom, and an error diffusion process is carried out. In the error diffusion process (Q⁻¹, ST, F, A), sustain-level quantization errors of the current filed are detected (Q⁻¹, ST) and transferred (F, A) to a next field, in which the sustain-level quantization errors are preferably compensated for.

### FIELD OF THE INVENTION

The present invention relates to a method and device for driving a plasma display panel including discharge cells each corresponding to a pixel in response to a video signal including fields wherein each field is formed by a plurality of subfields, comprising applying a sustain-level signal to cause a sustaining discharge in a discharge cell for emitting light therefrom, and carrying out an error diffusion process. Further, the present invention relates to a plasma display panel apparatus that comprises the mentioned device.

### BACKGROUND OF THE INVENTION

In recent years, a thin display apparatus has been requested in conjunction with an increase in size of the display panel. The plasma display panel (hereinafter simply referred to as “PDP”) is expected to become one of the most important display devices of the next generation which replaces the conventional cathode ray tube, because the PDP can easily realize reduction of thickness and weight of the panel and the provision of a flat screen shape and a large screen surface.

In the PDP that makes a surface discharge, a pair of electrodes is formed on an inner surface of a front glass substrate and a rare gas is filled within the panel. When a voltage is applied across the electrodes, a surface discharge occurs at the surface of a protection layer and a dielectric layer formed on the electrode surface, thereby generating ultraviolet rays. Fluorescent materials of the three primary colors red, green and blue are coated on an inner surface of a back glass substrate, and a color display is made by exciting the light emission from the fluorescent materials responsive to the ultraviolet rays.

The PDP comprises a plurality of column electrodes (address electrodes) and a plurality of row electrodes arranged so as to intersect the column electrodes. Each of the row electrodes pairs and the column electrodes are covered by a dielectric layer against a discharge space and have a structure such that a discharge cell corresponding to one pixel is formed at an intersecting point of the row electrode pair and the column electrode. Since the PDP provides a light emission display by using a discharge phenomenon, each of the discharge cells has only two states; a state where the light emission is performed and a state where it is not performed. A sub-field method is used to provide a halftone luminance display by the PDP. In the sub-field method, a display period of one field is divided into N sub-fields, a light emitting period having a duration period corresponding to a weight of each bit digit of the pixel data (N bits) is allocated every sub-field, and the light emission driving is performed.

The discharge is achieved by adjusting voltages between the column and row electrodes of a cell composing a pixel. The amount of discharged light changes to adjust the number of discharges in the cell. The overall screen is obtained by driving in a matrix type a write pulse for inputting a digital video signal to the column and row electrodes of the respective cells, a scan pulse for scanning a sustain pulse for sustaining discharge, and an erase pulse for terminating discharge of a discharged cell. Also, a gray scale is implemented by differentiating the number of discharges of each cell for a predetermined time required for displaying the entire picture.

The luminance of a screen is determined by the brightness for the case when each cell is driven to a maximum level. To increase the luminance, a driving circuit must be constructed such that the discharge time of a cell can be maintained as long as possible for a predetermined time required for forming a screen. The contrast, which is a difference in light and darkness, is determined by brightness and luminance of a background such as illumination. To increase the contrast, the background must be dark and the luminance thereof must be increased.

In common PDP display systems, a frame or field of a video signal information is displayed as a set of subfields. The subfields are often driven according the Address Display Separated (ADS) driving scheme. Each subfield has its own address, sustain and erase period. The erase period produces a small quantity of light on the complete display area. Active addressing of a pixel-element creates one light-flash in the addressed pixel-element. Only the sustain-period generates light on request, controlled by a number of sustain-pulses. Each sustain-pulse generates two discharges representing a pair of light-flashes.

The ratio of luminance values for each of the subfields depends on the selected subfield distribution in the subfield generation process. The total number of sustain-pulses per frame or field may vary, depending on parameters like power-supply-load, subfield-image load and panel-temperature. These input parameters are processed, and the total number of sustain-pulses per frame or field is calculated by a micro controller. In this process the total number of sustain-pulses per frame or field must be converted to a sustain-level per subfield (SF-sustain-level), expressed as a discrete number of sustain pulses. The exact subfield distribution must be maintained during the complete process, while the luminance ratio of the subfields must be preserved. Otherwise image artifacts will occur.

However, conventional sub-field distributions used in ADS systems are not always accurate. They not only suffer from limited gray-levels, but also have mismatches in their representation.

For panels with limited number of subfields or large amount of dithering, the SF-sustain-level may have a rather big quantization error. When displaying e.g. a gray-scale bar from dark to light, this can lead to a non-monotone rising light generation along the gray-scale, causing visible PDP imaging artifacts.

U.S. Pat. No. 6,144,364 A discloses a display driving method which drives a display to make a gradation display on a screen of the display depending on a length of a light emission time in each of sub fields forming 1 field, where 1 field is a time in which an image is displayed, N subfields form 1 field, and each subfield includes an address display-time in which a wall charge is formed with respect to all pixels which are to emit light within the subfield and a sustain time which is equal to the light emission time and determines a luminance level. The display driving method includes the steps of setting the sustain times of each of the subfields approximately constant within 1 field, and displaying image data on the display using N+1 gradation levels from a luminance level 0 to a luminance level N.

In U.S. Pat. No. 6,175,194 B1 a method for driving a plasma display panel is described wherein error diffusion and sustaining pulse control are used to reduce noise and prevent erroneous discharge to improve the display quality.

In U.S. Pat. No. 5,898,414 A, a display apparatus permitting high resolution and a large number of gray-scale levels and causing indiscernible flicker has been disclosed. One frame is divided into or composed of j subframes, and light is produced according to a luminance level predetermined subframe by subframe in order to express intermediate gray-scale of a picture. Emphasis is put on the fact that a display to be performed during each subframe within one frame can be controlled independently. An interlaced-scanning display is carried out during k subframes associated with low-order weighted bits out of j subframes, and a non-interlaced-scanning display is carried out during the other j-k subframes associated with high-order weighted bits. The ratio of an addressing scan time to a subframe associated with a small weight is large, and the ratio of an addressing scan time to a whole frame is very large. If the addressing scan time can be reduced as mentioned above, a great effect would be exerted. Moreover, the luminance levels to be determined in relation to the subframes during which interlaced-scanning display is carried out are so low that the influence of the reduction on a whole picture is limited.

U.S. Pat. No. 6,052,101 A describes a driving circuit for plasma display device and a gray scale implementing method therefore. The method includes the steps of dividing total horizontal lines of one frame into X×Y subframes according to a relative luminance ratio, dividing each frame into X subfields and allotting Y different subframes to each subfield, and supplying corresponding gray scale data while sequentially erasing each X×Y horizontal lines during one horizontal period from the first horizontal electrode lines to the last Nth horizontal electrode lines, included in Y different subframes allotted to each subfield by repeatedly driving X subfields and scanning the same, thereby implementing a display picture of 2^{X·Y} gray scales. At least two scanning and sustaining drivers are provided, and one frame is divided into one or more subfields by the drivers, different subframes are allotted to each subfield and then X subfields are repeatedly driven.

### SUMMARY OF THE INVENTION

It is an object of the present invention to increase the gray-level or color representation for improving the PDP image quality and to provide a feasible implementation of such improvement. To this end, the invention provides a PDP driving as defined by the independent claims. The dependent claims define advantageous embodiments.

The new technique of the present invention can be described as Sustain-level Error Diffusion (SED). With this technique the quantization error in the sustain-level generation is omitted, while the remaining error in a subfield sustain-level, hereinafter refer to as SF-sustain-level, is transferred to the next frame and incorporated in the next SF-sustain-level generation.

It is noted at that in the present text the term “field” can also mean a frame, and the term “subfield” (SF) can also mean a subframe. However, the present invention also covers a situation where a frame of a video signal consists of subframes, and a subframe consists of subfields.

For a given subfield distribution, only for very specific sustain-levels, all subfields can be displayed with a small quantization error. When adaptive regulations are active, sustain-levels can often not be accurately mapped due to quantization errors in the individual SF-sustain levels. A smart sustain-level regulation can avoid these errors by applying an error diffusion algorithm.

When for each subfield the SF-sustain-level quantization errors are forwarded to the next frame, the total quantization error can be neglected due to the integrating properties of the Human Visual System (HVS).

Preferably, the next frame is a succeeding frame.

The gray-level portrayal of PDP displays can be improved by using the SED technique of the present invention. In case of adaptive luminance regulation, this technique significantly improves the PDP image quality, while it removes sustain-level to luminance quantization errors. The SED technique of the present invention can be used for all PDP driving schemes. The implementation of the SED technique of the present invention only requires a small software modification of a given PDP display system architecture. So, the present invention provides for a feasible implementation that can be used in combination with other PDP image improvement algorithms, and, thus, does not add costs.

The sustain-level quantization errors of a specific subfield of a current field are transferred to the corresponding subfield of the next field. Hence, the technique is independent of any applied subfield distribution.

In a further preferred embodiment of the present invention, wherein the applying steps includes the generation of a SF-sustain-level, the transferred SF-sustain-level quantization errors are incorporated into the SF-sustain-level generation of the next frame.

In particular, the SF-sustain-level quantization errors are added to the requested SF-sustain-level of the next field.

In a still further preferred embodiment of the present invention the requested SF-sustain-level is generated on the basis of the total sustain-level signal and SF-distribution. The total sustain-level is divided over the subfields according to the subfield distribution ratio. It is rounded by a quantization process, and as a result of the rounding step an actual SF-sustain-level is obtained as an integer number and the remaining part of the requested SF-sustain-level as a quantization error. In particular, the requested SF-sustain-level is generated by calculation, usually by using a micro controller.

Moreover, an adaptive luminance regulation can be used, wherein the SED technique of the present invention significantly improves the PDP image quality, while it removes sustain-level to luminance quantization errors.

### BRIEF DESCRIPTION OF THE DRAWINGS

In the following, the present invention will be described in greater detail based on a preferred embodiment with reference to the accompanying drawings in which

FIG. 1 shows a block diagram of a PDP driving system;

FIG. 2 shows a block diagram of a sustain-level regulation; and

FIG. 3 shows an example of SF-sustain level quantization errors.

### DESCRIPTION OF THE PREFERRED EMBODIMENTS

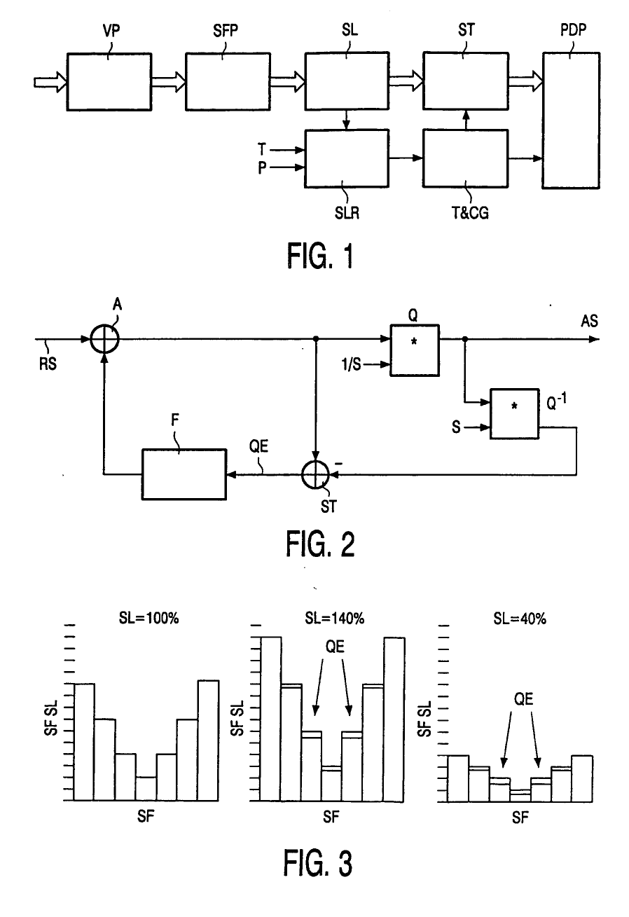

An implementation of the Sustain-level Error Diffusion (SED) technique is shown as block diagram in FIG. 1. FIG. 1 shows a video processor VP, a sub-field processor SFP, a sub-field load unit SL, a sub-field transpose unit ST, a plasma display panel PDP, a sustain level regulator SLR, and a timing & control generator T&CG. A temperature T and a power limit P are applied to the sustain level regulator SLR.

For each new frame of image-date, the active subfield-pixels are added to calculate the subfield load. The active subfield load, together with the power-limits and temperature parameters will determine the total number of sustain-pulses per frame. This is combined with the input video-signal timing and the subfield distribution settings, and a new set of sustain-levels is calculated for each subfield.

While this process is executed by a micro-controller, only software needs to be modified to support the SED technique.

For each frame the new set of sustain levels are forwarded to the Timing & Control process, before the first subfield of the frame is displayed.

When the SF(subfield)-sustain-level is calculated, also the sustain-periods are known. This information is relevant for the motion-compensated subfield calculations. This processes must be aware of the exact timing of each sustain period. It can be considered to maintain a fixed subfield timing-format and to fill the unused sustain-period with idle signals.

When for each subfield the SF-sustain-level quantization errors are compensated for in the next frame, the total quantization error can be neglected.

FIG. 2 schematically shows an embodiment of a sustain-level regulator SLR where an actual SF-sustain-level is generated on the basis of a requested SF-sustain-level by using a quantization process. In FIG. 2, a requested sustain RS is applied to an adder whose output is applied to a quantizer Q that outputs the actual sustain AS. S is a scaling factor. The actual sustain AS is applied to a de-quantizer Q⁻¹, whose output is subtracted from the input of the quantizer Q by a subtractor ST. The resulting quantizing error QE is filtered by a filter F, and thereafter added to the requested sustain by the adder A.

The requested SF-sustain-level SF SL for a subfield is calculated by a micro controller using sustain-level and SF-distribution data, and is expressed as a number type real. The actual SF-sustain-level SF SL is a number that must be integer. This implies a quantization process, which rounds the requested SF-sustain-level SF SL. The remaining part of the requested sustain (type real) is propagated to the related subfield in the next frame and added to the requested SF-sustain-level of that frame.

The filter characteristics are only a delay. The delay is a complete frame period minus the active sub-field period.

By providing a Sustain Level Regulation operation and a Timing and Control Generator, the SED technique is applied to forward SF-sustain-level SF SL errors to the next image field or frame. These stages calculate the sustain-levels and sustain-time for each subfield to adaptively regulate SF-sustain-levels SF SL for the PDP.

FIG. 3 shows an example of a SF distribution with various sustain-levels SL, namely with a sustain-level SL of 100% without any quantization errors QE, and with sustain-levels SL of 140% and 40% with quantization errors QE.

Although the invention is described above with reference to an example shown in the attached drawings, it is apparent that the invention is not restricted to it, but can vary in many ways within the scope disclosed in the attached claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

1. A method for driving a plasma display panel including discharge cells each corresponding to a pixel in response to a video signal including fields wherein each field is formed by a plurality of subfields, the method comprising:
applying a sustain-level signal to cause a sustaining discharge in a discharge cell for emitting light therefrom, and
carrying out an error diffusion process, characterized in that the error diffusion process comprises
detecting sustain-level quantization errors, and
transferring the sustain-level quantization errors of the current field to a next field.

2. A device for driving a plasma display panel including discharge cells each corresponding to a pixel in response to a video signal including fields wherein each field is formed by a plurality of subfields, the device comprising:
means for applying a sustain-level signal to cause a sustaining discharge in a discharge cell for emitting light therefrom, and
means for carrying out an error diffusion process, characterized in that the error diffusion process carrying out means comprise
means for detecting sustain-level quantization errors, and
means for transferring the sustain-level quantization errors of a current field to a next field.

3. The device according to claim 2, characterized in that the sustain-level quantization errors are compensated for in the next field.

4. The device according to claim 2, characterized in that the transferring means transfer the sustain-level quantization errors of a predetermined subfield of the current field to the corresponding subfield in the next field.

5. The device according to claim 2, wherein the applying means generate a sustain-level, and the transferring means incorporate the transferred sustain-level quantization errors into the next field sustain-level generation.

6. The device according to claim 4, characterized in that the transferring means incorporate the transferred sustain-level quantization errors into the next subfield sustain-level generation.

7. The device according to claim 2, characterized in that the transferring means add the transferred sustain-level quantization errors to the requested sustain-level of the next field.

8. The device according to claim 2, further comprising
means for generating a requested sustain-level on the basis of sustain-level and subfield distribution data,
quantization process means for rounding the requested sustain-level by a quantization process, and
means for generating an actual sustain-level as an integer number and the remaining part of the requested sustain-level as a quantization error in accordance with the result of the quantization process.

9. The device according to claim 2, further comprising luminance regulation means, preferably an adaptive luminance regulation means.

10. A plasma display panel apparatus comprising the device according to claim 2.
